(19) United States
(12) Patent Application Publication
(10) Pub. No.: US 2026/0149568 A1
(43) Pub. Date: May 28, 2026

(54) Transferring Payload Information Comprising Key Information

(71) Applicant: Volker Krummel, Paderborn (DE)

(72) Inventor: Volker Krummel, Paderborn (DE)

(73) Assignee: Utimaco IS GmbH, Aachen (DE)

(21) Appl. No.: 19/453,347

(22) Filed: Jan. 20, 2026

Related U.S. Application Data
(63) Continuation of application No. PCT/EP2024/071307, filed on Jul. 26, 2024.

(30) Foreign Application Priority Data
Jul. 28, 2023 (DE) 10 2023 120 112.3

(51) Int. Cl. H04L 9/08; H04L 9/32

(52) U.S. Cl. CPC H04L 9/0819; H04L 9/3228

(57) ABSTRACT

A method including the steps of obtaining key information from a secure electronic memory. The key information represents one or more keys. Determining, at least partially based on a plurality of session parameters and a master key, an encryption key. The plurality of session parameters includes a session identifier, a sender identifier and a receiver identifier. Encrypting at least partially based on the determined encryption key, the key information. Providing payload information. The payload information includes at least the encrypted key information and the sender identifier.

### CROSS-REFERENCE TO RELATED PATENT APPLICATIONS

This patent application is a continuation of International Application No. PCT/EP2024/071307, filed on Jul. 26, 2024, which claims the benefit of priority to German Patent Application No. 10 2023 120 112.3, filed Jul. 28, 2023, the entire teachings and disclosures of both applications are incorporated herein by reference thereto.

### TECHNICAL FIELD

Various exemplary embodiments according to the present disclosure relate to transferring key information representing electronic keys (e.g. one-time signatures (OTS) keys) between a source apparatus and a destination apparatus (e.g. between two hardware security modules (HSM)). Specifically, various exemplary embodiments according to the present disclosure relate to determining keys for encryption and authentication of key information based on a plurality of session parameters for generating payload information comprising encrypted key information. It is to be understood that the presentation of various exemplary embodiments in the following is merely by way of examples and is not to be construed as limitations on the scope of the present disclosure.

### BACKGROUND

OTS keys are primarily used in situations where integrity and non-repudiation are crucial, such as for example in secure communication protocols (e.g. secure email or instant messaging), authentication and authorization purposes (e.g. electronic voting systems) or digital timestamping (e.g. for signing a timestamp with an OTS key for preventing any possibility of tampering or retroactive modifications). For example, once an OTS key is used to sign a message, it should never be reused, as reusing the key could compromise security. Therefore, careful key management and secure key generation mechanisms are crucial in deploying OTS effectively. When managing and transferring OTS keys, their repeated usage must be prevented for security reasons, but at the same time high availability of the keys is to be ensured without restricting import or export of the keys.

### SUMMARY OF SOME EXEMPLARY EMBODIMENTS

Various example embodiments according to the present disclosure may have the effect of transferring key information representing one or more keys between a source apparatus and a destination apparatus in a way that guarantees confidentiality, authenticity and freshness (i.e. one-time usage) of the one or more keys.

According to a first aspect of the present disclosure, a method is disclosed, wherein the method comprises:
obtaining key information from a secure electronic memory, wherein the key information represents one or more keys;
determining, at least partially based on a plurality of session parameters and a master key, an encryption key, wherein the plurality of session parameters comprises a session identifier, a sender identifier and a receiver identifier;
encrypting, at least partially based on the determined encryption key, the key information; and
providing payload information, wherein the payload information comprises at least the encrypted key information and the sender identifier.

According to a second aspect of the present disclosure, a method is disclosed, wherein the method comprises:
obtaining payload information, wherein the payload information comprises a sender identifier and encrypted key information, wherein the key information represents one or more keys;
determining, at least partially based on a master key and a plurality of session parameters, a decryption key, wherein the plurality of session parameters comprises the sender identifier, a receiver identifier and a session identifier;
decrypting the key information at least partially based on the determined decryption key; and
storing the key information in a secure electronic memory.

According to a third aspect of the present disclosure, a method is disclosed, wherein the method comprises:
receiving, from a source apparatus, payload information, wherein the payload information comprises at least encrypted key information representing one or more keys and a sender identifier identifying the source apparatus, wherein the encrypted key information is encrypted at least partially based on an encryption key, wherein the encryption key is determined at least partially based on a plurality of session parameters, wherein the plurality of session parameters comprises the sender identifier, a receiver identifier identifying a destination apparatus and a session identifier identifying a transfer session between the source apparatus and the destination apparatus; and
providing the payload information to the destination apparatus.

Further according to the first, second and third aspect, a respective apparatus is disclosed, wherein the apparatus is configured to perform and/or control or wherein the apparatus comprises means (e.g. computer means) for performing and/or controlling the respective method according to the first, second or third aspect. Such means of the apparatus may for example be implemented in hardware and/or software. They may comprise for example at least one processor for executing computer program code for performing the required functions, at least one memory storing the program code, or both. Alternatively or additionally, they may for example comprise circuitry that is designed to implement the required functions, for example implemented in a chipset or a chip, like an integrated circuit. In general, the means may comprise for example one or more processing means or processors.

Further according to the first, second and third aspect, a respective apparatus is disclosed, comprising at least one processor and at least one memory including computer program code, the at least one memory and the computer program code configured to, with the at least one processor, cause the apparatus at least to perform and/or to control the respective method according to the first, second or third aspect.

An apparatus according to the first or second aspect may for example be a respective hardware security module (HSM) or a respective unit (e.g. a control unit) of an HSM. An HSM may for example be understood as a device that safeguards and manages and/or generates electronic keys, performs encryption and decryption, authentication and other cryptographic functions. For example, an HSM may comprise tamper-resistant and tamper-evident hardware components, such as secure chips and sensors, for preventing unauthorized access, hacking or physical attacks. In particular, an HSM may for example comprise a secure cryptographic processor configured to provide cryptographic functions and secure key management. An HSM may for example further comprise a secure electronic memory for storing cryptographic keys and other sensitive data. Such an electronic memory may be secured by physical security measures and may include tamper-resistant features to prevent unauthorized access. To give some non-limiting examples, these physical security measures may be tamper-evident seals, intrusion detection sensors or self-destruct mechanisms to prevent physical attacks and tampering. An HSM may for example further comprise one or more secure communication interfaces, which may allow for secure data transfer. To give some non-limiting examples, these secure communication interfaces may be USB, Ethernet, or similar communication interfaces that support secure transmission protocols. An HSM may for example be operated by a particular management software that allow for configuring the HSM, monitoring usage and managing keys or security policies.

An apparatus according to the third aspect may for example be a network apparatus (e.g. a network server) that may be configured to manage network resources (e.g. network traffic) within a network (e.g. a Local Area Network, Wide Area Network or Cellular Network). Therein, a network (e.g. a computer network) may for example be understood as group of interconnected devices (e.g. computers, servers, printers, and other hardware) that may be connected through communication channels (e.g. wires, fibre optics, or wireless connections) for facilitating communication and resource sharing. For example, the network apparatus according to the third aspect may be part of a network including one or more apparatuses according to the first or second aspect (e.g. one or more HSM).

Further according to the first, second and third aspect, a respective computer program is disclosed, wherein the computer program when executed by a processor of an apparatus causes the apparatus to perform the respective method according to the first, second or third aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for example a Read-Only Memory (ROM) or hard disk of a computer, or be intended for distribution of the program, like an optical disc.

According to a fourth aspect of the present disclosure, a system is disclosed, wherein the system comprises:
the apparatus according to the first aspect; and
the apparatus according to the second aspect.

For example, the system may comprise at least one source apparatus (e.g. an HSM) according to the first aspect and at least one destination apparatus (e.g. an HSM) according to the second aspect. Further, the system may comprise at least one further destination apparatus (e.g. at one further HSM). Further, the system may comprise an application that may be understood as an apparatus according to the third aspect, which may be a network server as part of a network (e.g. a Local Area Network, Wide Area Network or Cellular Network) that includes the at least one source apparatus and the at least one destination apparatus and that may be used for key transfer. In another example, the application may be understood as a portable data storage device (e.g. a USB flash drive), on which the payload information may be temporarily stored and transferred from the at least one source apparatus to the at least one destination apparatus.

For example, the one or more keys may be understood as electronic, digital or cryptographic keys, that may be a piece of digital information used in cryptography to secure electronic information. For example, the one or more keys may be given by a secret parameter or value that is known and utilized by authorized parties to perform cryptographic operations securely. In particular, a key may be a binary string or a sequence of characters, which may be represented in various formats, including hexadecimal, binary, or alphanumeric. To give some non-limiting examples, the one or more keys may be encryption keys or decryption keys (as e.g. used in symmetric or asymmetric encryption algorithms), digital signature keys (e.g. a private key for generating a digital signature and a public key for verifying the authenticity of the signature) or authentication keys (e.g. as used in cryptographic algorithms, such as HMAC (Hash-based Message Authentication Code), to ensure secure authentication and prevent unauthorized access).

In another example, the one or more keys may be OTS keys, which may be understood as a type of cryptographic key used in digital signatures. Unlike for example traditional digital signature schemes that use a single key pair for multiple signatures, an OTS key is used only once for a single signature. For example, once the OTS key is used, it becomes useless and cannot be reused for any other signature. State information of an OTS key may for example indicate a state of an OTS key, which state is whether the OTS key has already been used or not.

Key information representing one or more keys may for example be understood as the actual one or more keys. For example, assuming that a key may be a binary string or a sequence of characters, the key information representing the key may be the binary string or the sequence of characters that is the key represented by the key information.

In another example, key information of one or more keys may be understood as an information indicating the one or more keys without being the actual one or more keys. In such a case, the key information representing a key may be an information (e.g. an indicator, index, value or identifier) based on which it may be possible to obtain (e.g. retrieve, determine or uniquely identify) the actual key represented by the key information. For example, the key information of a key may uniquely identify or locate the key within a plurality of keys (e.g. within a key structure such as a key tree structure or within a key database or storage system) by a numerical or textual value.

For example, considering a key transfer between a source apparatus and a destination apparatus, the actual keys may be transferred as part of the payload information. In another example, not the actual keys but key information identifying the keys may be transferred as part of the payload information,

Obtaining key information from a secure electronic memory may for example be understood to mean that the source apparatus retrieves the key information from the secure electronic memory of the source apparatus (e.g. for the purpose of transferring the key information to a destination apparatus). Alternatively or additionally, obtaining key information may comprise determining the key information at least partially based on further information retrieved from the secure electronic memory. Further, storing key information in the secure electronic memory may be understood to mean that the destination apparatus may store the key information in the secure electronic memory of the destination apparatus (e.g. after receiving the key information from a source apparatus). For example, destination may store the one or more keys represented by the key information, which may comprise determining the one or more keys based on the key information.

For example, obtaining key information representing one or more keys may be performed after receiving a request indicating that the one or more keys are to be transferred to a destination apparatus. This may for example comprise verifying the received request to determine whether the requested one or more keys are available at the source apparatus and unused.

A plurality of session parameters may for example comprise a sender identifier, a receiver identifier and a session identifier. Considering for example that the payload information is transferred from a source apparatus to a destination apparatus, the sender identifier identifies the source apparatus, the receiver identifier identifies the destination apparatus and the session identifier identifies a transfer session between the source apparatus and the destination apparatus for transferring the payload information.

The master key may be used for both the method according to the first and second aspect and thus may for example be available at both the apparatus according to the first aspect (e.g. a source apparatus) and the apparatus according to the second aspect (e.g. a destination apparatus). For example, the master key is stored at the source apparatus and also at the destination apparatus (e.g. in respective secure electronic memories of the apparatuses).

The master key may for example be understood as electronic, digital or cryptographic key that is used in symmetric encryption algorithms. In particular, the master key may be a binary string or a sequence of characters, which may be represented in various formats, including hexadecimal, binary, or alphanumeric. Considering for example a key transfer between a source apparatus and a destination apparatus, the master key is available at both the source apparatus and the destination apparatus. For example, it may be stored in the secure electronic memory of the source apparatus and in the secure electronic memory of the destination apparatus. The master key may then be understood as shared symmetric key, wherein at the source apparatus the master key is used for determining the encryption key for encrypting the key information, and wherein at the destination apparatus the master key is used for determining the decryption key for decrypting the encrypted key information.

Determining the encryption key and the decryption key at least partially based on a plurality of session parameters and a master key may for example be understood to mean that the encryption key and the decryption key is determined (e.g. derived or generated) according to a respective cryptographic function (e.g. a key derivation function) that uses at least the plurality of session parameters and the master key as input. This may for example include transforming the plurality of session parameters and the master key according to the cryptographic function into the encryption key or the decryption key, wherein the cryptographic function may for example employ various cryptographic protocols with specific properties such as randomness or uniqueness of the resulting key.

Considering for example a key transfer between a source apparatus and a destination apparatus, the encryption key may be determined by the source apparatus for encrypting the key information and the decryption key may be determined at the destination apparatus for decrypting the encrypted key information. In such an example, respective cryptographic functions may be used at the source apparatus and destination apparatus to determine the encryption key and decryption key, respectively. For example, the determined encryption key and decryption key may be equal or different to each other. Advantageously, the source apparatus and destination apparatus may respectively determine the encryption key and decryption key independently of each other based on the master key that is already shared between the source apparatus and destination apparatus. Further, by relying on the plurality of session parameters, the encryption key and decryption key are determined individually for a specific key transfer session and a specific role distribution of the source apparatus and destination apparatus.

When using the plurality of session parameters as input for determining the encryption key and decryption key, it may be understood that the sequence of the session parameters may affect the determined encryption key and decryption key. Accordingly, the role of an apparatus as sender or receiver may be taken into account when determining the encryption key and decryption key. For example, considering a key transfer between a source apparatus and a destination apparatus, the session parameters may be given by the sender identifier of the source apparatus, the receiver identifier of the destination apparatus and the session identifier. If the sender and receive role of source apparatus and destination apparatus would be reversed, the plurality of session parameters would be the same but the determined encryption key and decryption key would be different because the sequence of the sender identifier and receiver identifier would have changed.

Encrypting, at least partially based on the determined encryption key, the key information and decrypting the key information at least partially based on the determined decryption key may for example be understood to mean that the key information is transferred from its original form into a coded form and vice versa. For example, encryption may be the process of converting the key information plaintext into ciphertext using an encryption algorithm and the encryption key, while decryption is the process of converting the encrypted key information from ciphertext back into its original plaintext using a decryption algorithm and the corresponding decryption key. For example, various symmetric-key algorithms may be used for encrypting and decrypting the key information (e.g. Advanced Encryption Standard (AES), Data Encryption Standard (DES) or Rivest-Shamir-Adleman (RSA)).

After encrypting the key information, the payload information is generated based on the encrypted key information and the plurality of session parameters. In particular, the payload information at least includes the encrypted key information and the sender identifier and may further include the receiver identifier and session identifier. As further described in an example below, generating payload information may also include authenticating the encrypted key information.

For example, generating the payload information based on the encrypted key information and the plurality of session parameters may be understood to comprise collecting, formatting, encoding, compressing and/or packaging the key information and the plurality of session parameters. For example, generating the payload information may comprise formatting the encrypted key information and the plurality of session parameters in a standard format (e.g. a format that is public and that may be adapted by various vendors).

After generating the payload information, the payload information may for example be provided by the source apparatus and subsequently obtained by the destination apparatus. This may be understood to mean that the payload information may be transmitted over a communication channel (e.g. a secure communication channel) between the source apparatus and the destination apparatus. In some examples, the source apparatus and the destination apparatus may be part of a communication network (e.g. a Local Area Network, Wide Area Network or Cellular Network) that may be used to transmit the payload information. In other examples, the payload information may be transferred from the source apparatus to the destination apparatus by means of an application as additional instance between the source apparatus and destination apparatus. Therein, the application may for example be understood as a network server as part of a network (e.g. a Local Area Network, Wide Area Network or Cellular Network) that includes the source apparatus and the destination apparatus and that may be used for key transfer. In another example, the application may be understood as a portable data storage device (e.g. a USB flash drive), on which the payload information may be temporarily stored and transferred from the source apparatus to the destination apparatus. It may be understood that any period of time may elapse between providing the payload information by the source apparatus (e.g. by storing the payload information on the portable data storage device) and obtaining the payload information by the destination (e.g. by retrieving the payload information from the portable data storage device).

In the following, further exemplary features and exemplary embodiments of the different aspects of the present disclosure will be described in more detail.

According to an exemplary embodiment of the first aspect of the present disclosure, the provided payload information further comprises the session identifier and the receiver identifier.

According to an exemplary embodiment of the second aspect of the present disclosure, the obtained payload information further comprises the session identifier and the receiver identifier.

As described above, the plurality of session parameters comprising the sender identifier, receiver identifier and session identifier are used to determine the encryption key and the decryption key. It may for example not be required to include all of these session parameters in the payload information. In an example where the sender identifier, receiver identifier and session identifier are included in the payload by the source apparatus when generating the payload information, the destination apparatus may for example use the sender identifier, receiver identifier and session identifier as included in the payload information when determining the decryption key. This may improve security of the key transfer, because the destination apparatus may for example first verify the receiver identifier or the session identifier included in the payload information before extracting the payload information. In other examples where the payload information does not include the receiver identifier and/or the session identifier, the destination apparatus may assume its own identifier available at the destination apparatus as receiver identifier and may further derive the session identifier from a previous session identifier available at the destination apparatus. Such an option may be advantageous because it may reduce the amount of information that needs to be transferred between the source apparatus and destination apparatus.

According to an exemplary embodiment of the first aspect of the present disclosure, the method according to the first aspect further comprises:
determining an authentication information at least partially based on an authentication key, the key information and the plurality of session parameters, wherein the provided payload information further comprises the determined authentication information.

For example, determining the authentication information at least partially based on an authentication key, the key information and the plurality of session parameters (i.e. including the receiver identifier, the sender identifier and the session identifier) may be understood as authenticating the key information and the plurality of session parameters. In particular, the authentication information may be determined based on the key information, wherein the key information is encrypted or not encrypted.

For example, a source apparatus may determine a message authentication code (MAC) as authentication information based on the key information, the session parameters (i.e. including the receiver identifier, the sender identifier and the session identifier) and an authentication key K_mac. In addition to the encrypted key information, the payload information provided then further comprise the MAC authenticating the key information and the session parameters. For encrypting and authenticating the key information, methods for achieving authenticated encryption such as Authenticated Encryption with Associated Data (e.g. AES-GCM) may be used by the source apparatus.

Advantageously, authenticating the key information and the session parameters improves security of the key transfer, in particular by providing authenticity of the transferred key information and further of the session parameters. The authenticity of the key information in combination with the authenticity of the session parameters may guarantee the freshness of the key information and may allow for detecting a replay attack.

According to an exemplary embodiment of the first aspect of the present disclosure, the method according to the first aspect further comprises:
determining the authentication key at least partially based on the plurality of session parameters and the master key.

For example, the authentication key may be determined (e.g. derived or generated) by the source apparatus based on the sender identifier, the receiver identifier and the session identifier as session parameters and on the master key stored at the source apparatus according to a respective cryptographic function (e.g. a key derivation function) that uses at least the plurality of session parameters and the master key as input. Advantageously, the source apparatus may determine the authentication key independently of the destination apparatus based on the master key that is already shared between the source apparatus and destination apparatus. Further, by relying on the plurality of session parameters, the authentication key is determined individually for a specific key transfer session and a specific role distribution of the source apparatus and destination apparatus.

According to an exemplary embodiment of the first aspect of the present disclosure, the method according to the first aspect further comprises:
receiving request information indicating the one or more keys;
determining whether the one or more keys indicated by the request information are available and unused.

For example, a source apparatus performing the method according to the first aspect may receive request information from an apparatus according to the third aspect (e.g. an application that may be a network server), wherein the request information indicate that the source apparatus is requested to send one or more keys to a destination apparatus that is identified by a corresponding receiver identifier. The request information may for example indicate one or more particular keys that are to be sent to the destination apparatus, or in another example may indicate that a particular amount of keys is to be sent without specifying any particular keys.

Subsequently, the source apparatus may for example verify the request information, which may comprise determining whether the one or more keys indicated by the request information are available at the source apparatus (e.g. in the secure electronic memory of the source apparatus). If available, the source apparatus may further determine based on state information whether the corresponding keys are unused. If the corresponding keys are for example not available at the source apparatus or are available but already used, the method may not continue.

According to an exemplary embodiment of the first aspect of the present disclosure, the method according to the first aspect further comprises:
determining an updated state of the one or more keys.

For example, after providing the payload information, the source apparatus may determine an updated state of the one or more key represented by the key information included in the payload information. This may comprise updating state information stored at the source apparatus to indicate that the one or more keys are used.

According to an exemplary embodiment of the first aspect of the present disclosure, the method according to the first aspect further comprises:
providing an indication of the one or more keys represented by the key information.

For example, after receiving request information indicating the one or more keys and after determining that the one or more keys indicated by the request information are available and unused, the source apparatus may provide (e.g. transmit) an indication of the one or more keys represented by the key information included in the payload information to an application (e.g. a network server). Advantageously, such an indication may be used by the application to collect confirmation information from at least one further destination apparatus indicating whether the one or more keys have not been used before.

According to an exemplary embodiment of the second aspect of the present disclosure, the method according to the second aspect further comprises:
verifying, before determining the decryption key, the receiver identifier included in the payload information.

For example, after obtaining the payload information at the destination apparatus and before determining the decryption key, the destination apparatus may verify the receiver identifier included in the payload information by checking whether the receiver identifier included in the payload information matches an identifier identifying the destination apparatus that may be stored at the destination apparatus to verify that the transferred payload information is intended for the destination apparatus.

According to an exemplary embodiment of the second aspect of the present disclosure, the method according to the second aspect further comprises:
verifying the key information and the plurality of session parameters, at least partially based on the authentication information and a verification key.

For example, verifying the key information and the plurality of session parameters at least partially based on the authentication information and the verification key may be understood as checking the authenticity of the key information and the plurality of session parameters. In particular, the key information may be verified in encrypted or decrypted form.

For example, a destination apparatus may determine a message authentication code (MAC) based on the key information, the session parameters (i.e. including the receiver identifier, the sender identifier and the session identifier) included in payload information obtained at the destination apparatus and a verification key. For verifying the key information and the session parameters, the MAC determined by the destination apparatus may be compared with the MAC that is included in the payload information and that is determined by source apparatus before transferring the key information to the destination apparatus. If the MAC determined by destination apparatus matches the MAC that is included in the payload information, the key information and the session parameters included in the payload information are verified.

Advantageously, verifying the key information and/or the session parameters improves security of the key transfer, in particular by providing authenticity of the transferred key information and further of the session parameters. The authenticity of the key information in combination with the authenticity of the session parameters may guarantee the freshness of the key information and may allow for detecting a replay attack.

According to an exemplary embodiment of the second aspect of the present disclosure, the method according to the second aspect further comprises:
determining the verification key at least partially based on the plurality of session parameters and the master key.

For example, the verification key may be determined (e.g. derived or generated) by the destination apparatus based on the sender identifier, the receiver identifier and the session identifier as session parameters and on the master key stored at the destination apparatus according to a respective cryptographic function (e.g. a key derivation function) that uses at least the plurality of session parameters and the master key as input. Advantageously, the destination apparatus may determine the verification key independently of the source apparatus based on the master key that is already shared between the source apparatus and destination apparatus. Further, by relying on the plurality of session parameters, the verification key is determined individually for a specific key transfer session and a specific role distribution of the source apparatus and destination apparatus.

According to an exemplary embodiment of the second aspect of the present disclosure, the method according to the second aspect further comprises:
providing status information indicating the one or more keys.

For example, the destination apparatus may confirm to an application from which the payload information is obtained that the one or more keys represented by the key information included in the payload information have been received at the destination apparatus, for example by providing corresponding status information indicating the one or more keys to the application.

According to an exemplary embodiment of the second aspect of the present disclosure, the method according to the second aspect further comprises:
determining a state of the one or more keys.

For example, after decrypting the key information included in the obtained payload information and before or after storing the key information in the secure electronic memory of the destination apparatus, the destination apparatus may determine a state of the one or more keys represented by the key information, wherein the destination apparatus may determine state information of the one or more keys indicating that these one or more keys are unused and thus available for further use at the destination apparatus.

According to an exemplary embodiment of the second aspect of the present disclosure, the method according to the second aspect further comprises:
obtaining confirmation information indicating whether the one or more keys represented by the key information are unused, wherein the key information is stored in the secure electronic memory when the confirmation information indicates that the one or more keys are unused.

For example, a destination apparatus may obtain from an application (e.g. a network server) confirmation information indicating whether the one or more keys represented by the key information are unused. Advantageously, such confirmation information may be provided by the application after collecting confirmation information at the application from at least one further destination apparatus indicating whether the one or more keys have not been used before.

For example, the destination apparatus may only use (e.g. decrypt, verify or store) the one or more keys represented by the transferred key information if the confirmation information indicates that the one or more keys have not been used before. Otherwise, the destination apparatus may discard the transferred one or more keys.

According to an exemplary embodiment of the various aspects of the present disclosure, the payload information is transferred from a source apparatus to a destination apparatus, and the following holds:
the sender identifier identifies the source apparatus;
the receiver identifier identifies the destination apparatus; and
the session identifier identifies a transfer session between the source apparatus and the destination apparatus for transferring the payload information.

According to an exemplary embodiment of the various aspects of the present disclosure, the one or more keys are OTS keys and/or the one or more keys represent a key slice.

For example, OTS keys may be understood as a type of cryptographic key used in digital signatures that is used only once for a single signature. For example, once the OTS key is used, it becomes useless and cannot be reused for any other signature. State information of an OTS key may for example indicate a state of an OTS key, which state is whether the OTS key has already been used or not. Advantageously, the methods according to the various aspects provides a secure approach of transferring such OTS keys between a source apparatus and a destination apparatus while guaranteeing the freshness of the transferred OTS keys.

For example, one or more keys may represent a key slice such that a key slice may refer to a group or a subset including the one or more keys out of a plurality of keys. In other words, a key slice may be understood as a portion or division of a larger set of cryptographic keys. For example, in some cryptographic systems or key management schemes, a set of keys may be divided or segmented into smaller groups for various purposes (e.g. distribution, access control or scalability), wherein each of these smaller groups of keys may be referred to as a key slice. For example, in a multi-tiered encryption system, different key slices may be used at different levels of the system's architecture. Key slicing may for example be utilized in scenarios where a cryptographic system may generate a master key and then divide it into multiple key slices that are distributed to different entities or individuals. Only when all the key slices are combined can the master key be reconstructed, ensuring that no single entity has complete access to the entire key.

According to an exemplary embodiment of the third aspect of the present disclosure, the method according to the third aspect further comprises:
obtaining, from the source apparatus, an indication of the one or more keys represented by the key information;
transmitting, to at least one further destination apparatus, a request to indicate whether the one or more keys are unused;
receiving, from the at least one further destination apparatus in response to the request, confirmation information indicating whether the one or more keys are unused; and
providing the confirmation information to the destination apparatus.

As described above, the payload information may be transferred from a source apparatus to a destination apparatus by means of an application as additional instance between the source apparatus and destination apparatus. Therein, the application may for example be understood as a network server (as example for an apparatus according to the third aspect) as part of a network (e.g. a Local Area Network, Wide Area Network or Cellular Network) that includes the source apparatus and the destination apparatus and that may be used for key transfer. For example, this network may further comprise at least one further destination apparatus.

The application may for example receive from the source apparatus an indication of the one or more keys represented by the payload information that is transferred from the source apparatus to the destination apparatus. The application may then transmit a request to the at least one further destination apparatus to indicate whether the one or more keys indicated by the source apparatus are unused. The at least one further destination apparatus may then for example check if any information (e.g. state information) on the one or more keys is available at the at least one further destination apparatus that may indicate that the one or more OTS have been used before or have been transferred to the at least one further destination apparatus before (e.g. in a previous transfer session between the source apparatus and the at least one further destination apparatus). In response to the request by the application, the at least one further destination apparatus may then transmit confirmation information to indicate whether the one or more keys are unused. This may be understood to mean that the confirmation information may at least indicate whether the one or more keys have not been used at the at least one further destination apparatus or have not been transferred to at least one further destination apparatus, while it may still be that they have been used at another further destination apparatus or transferred to another further destination apparatus.

In another example assuming a plurality of further destination apparatuses, the application may request at each further destination apparatus of the plurality of destination apparatuses to indicate whether the one or more keys are unused and may then forward confirmation information from each further destination apparatus of the plurality of destination apparatuses to the destination apparatus. The destination apparatus that obtained the payload information may then only use the one or more keys transferred from the source apparatus (e.g. verify, decrypt and/or store) if each confirmation information of the plurality of confirmation information indicates that the one or more keys have not been used before. Otherwise, the destination apparatus may discard the transferred one or more keys.

Advantageously, the destination apparatus may then use the confirmation information from at least one further destination apparatus to ensure that transferred one or more keys are unused. This way, the destination apparatus may detect replay attacks by checking whether received keys have been transferred in a previous transfer session to another destination apparatus.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

Some example embodiments will now be described with reference to the accompanying drawings.

FIG. 1 shows an exemplary embodiment of a system according to the fourth aspect of the present disclosure;

FIG. 2 shows a flow chart illustrating an exemplary embodiment of a method according to the first aspect of the present disclosure;

FIG. 3 shows a flow chart illustrating an exemplary embodiment of a method according to the second aspect of the present disclosure;

FIG. 4 shows a flow chart illustrating an exemplary embodiment of a method according to the third aspect of the present disclosure;

FIG. 5 shows a signalling chart illustrating an exemplary embodiment according to the various aspects of the present disclosure;

FIG. 6 shows an exemplary embodiment of a system according to the fourth aspect of the present disclosure;

FIG. 7 shows a block diagram of an exemplary embodiment of an apparatus according to the first or second aspect of the present disclosure;

FIG. 8 shows a block diagram of an exemplary embodiment of an apparatus according to the third aspect of the present disclosure; and

FIG. 9 is a schematic illustration of examples of tangible and non-transitory computer-readable storage media.

### DETAILED DESCRIPTION OF THE FIGURES

The following description serves to deepen the understanding of the present disclosure and shall be understood to complement and be read together with the description of exemplary embodiments of the present disclosure as provided in the above summary section of this specification.

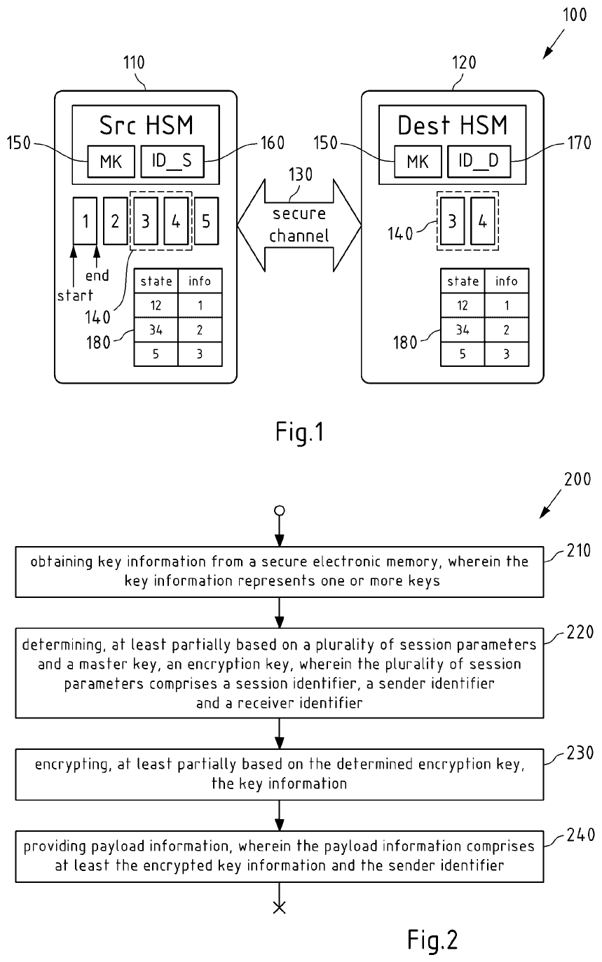

FIG. 1 shows an exemplary embodiment of a system 100 according to the fourth aspect of the present disclosure.

Without limiting the scope of the present disclosure, system 100 may comprise two apparatuses, which may be assumed to be two hardware security modules (HSM) 110, 120 in the following. In particular, HSM 110 (see “Src HSM” in FIG. 1) may be understood as source apparatus and HSM 120 (see “Dest HSM” in FIG. 1) may be understood as destination apparatus. Further, HSM 110 and HSM 120 may each be understood as a respective device that safeguards and manages and/or generates electronic keys, performs encryption and decryption, authentication and other cryptographic functions. HSM 110 and HSM 120 may comprise tamper-resistant and tamper-evident hardware components, such as secure chips and sensors, for preventing unauthorized access, hacking or physical attacks.

As an example, a plurality of electronic keys 1, 2, 3, 4 and 5 may be stored in a secure electronic memory of HSM 110, wherein these electronic keys may be identified (e.g. identified within a key structure such as a key tree structure) by respective values (see “start”, “end” in FIG. 1). Electronic keys 1, 2, 3, 4 and 5 may be one-time signature (OTS) keys, wherein OTS keys 3 and 4 as part of key slice 140 shall be transferred from HSM 110 to HSM 120 via a secure transmission channel 130 between HSM 110 and HSM 120. Both HSM 110, 120 may store state information 180 indicating a respective state of electronics keys stored at the secure electronic memory of HSM 110, 120 (e.g. keys 3 and 4).

In the non-limiting example of FIG. 1, an OTS key may be understood as cryptographic key that is used only once for a particular signature, while reusing an OTS key may lead to potential forgery (e.g. by compromising the security of the signature scheme). State information of an OTS key may therefore indicate a state of an OTS key, which state is whether the OTS key has already been used or not. For example, such state information of an OTS key need to be kept current, in particular before the OTS key is requested for use to ensure freshness of the OTS key.

Further referring to HSM 110 and HSM 120, both may store a master key 150 (see “MK” in FIG. 1), which may be understood as cryptographic key for a symmetric encryption algorithm, wherein the same master key 150 may be used for encryption at HSM 110 and for decryption at HSM 120. It may further be assumed that HSM 110 as source apparatus is identified by a sender identifier ID_S and HSM 120 as receiving apparatus is identified by a receiver identifier ID_D, wherein ID_S and ID_D may be stored in respective secure electronic memories of HSM 110 and HSM 120.

Regarding a transfer of OTS key between HSM 110 and HSM 120, security as well as availability may be seen as key requirements for ensuring a secure transfer mechanism for unused OTS keys between trustworthy HSM. In particular, the reusage of OTS keys needs to be prevented with regard to security without affecting availability by for example import or export restriction of OTS keys. In addition, vendor-lock-in concerns may be addressed to allow for migrating the secure transfer mechanism to other security solutions or to ensure compatibility with industry standards.

Further with reference to the non-limiting example of FIG. 1, a precondition for securely transferring key slice 140 including key 3 and key 4 between HSM 110 and HSM 120 may be that each HSM maintains its local state (e.g. the states of keys stored in the respective HSM) and that a trustworthy relationship between HSM 110 and HSM 120 is present (e.g. by means of a master key MK being shared by both HSM).

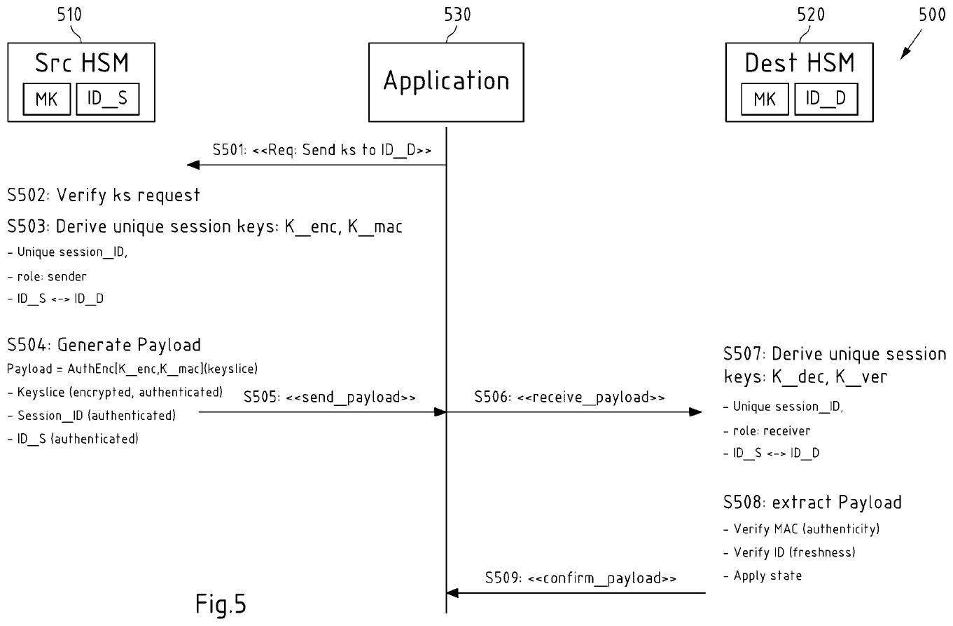

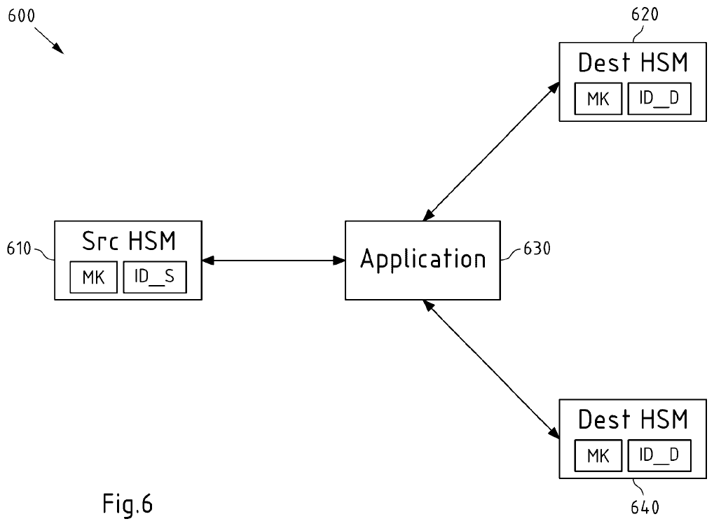

Regarding the actual key slice transfer, a first step may concern verifying the freshness of the keys in key slice 140 to be transferred by verifying that the keys 3 and 4 are in an unused state. Thereafter, a secure transfer channel 130 between HSM 110 and 120 may be established (e.g. by means of an application as further described with reference to FIG. 5 and FIG. 6 below). The key slice 140 may then be transferred from HSM 110 to HSM 120 (e.g. in a universal format to avoid vendor-lock-in scenarios) and the respective states of keys 3 and 4 may be updated at HSM 110 indicating that keys 3 and 4 are used. In response to transferring key slice 140 from HSM 110 to HSM 120, HSM 110 may receive a confirmation (e.g. from HSM 120 or from an application providing the secure transfer channel 130) indicating that key slice 140 has been successfully transferred or that the transfer of key slice 140 has failed. As post-condition after successful transfer, HSM 110 may nullify the keys 3 and 4 and HSM 120 may be able to use these keys 3 and 4. As post-condition after failed transfer, HSM 110 may also nullify the keys 3 and 4.

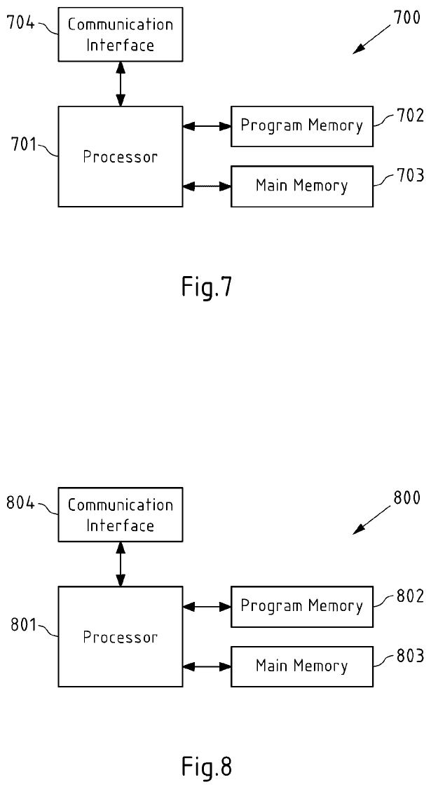

FIG. 2 shows a flow chart 200 illustrating an exemplary embodiment of a method according to the first aspect of the present disclosure. It may for example be assumed that the steps of flow chart 200 are performed and/or controlled by an apparatus according to the first aspect of the present disclosure (e.g. apparatus 700 described with reference to FIG. 7 as source apparatus).

Without limiting the scope of the present disclosure, the steps of flow chart 200 are described in following in view of system 100 according to FIG. 1.

Step 210 is obtaining key information from a secure electronic memory, wherein the key information represents one or more keys.

For example, HSM 110 may obtain key information from a secure electronic memory of HSM 110, wherein the key information represents OTS keys 3 and 4, which form key slice 140. In this example, key information representing OTS keys 3 and 4 may be understood to represent the actual OTS keys 3 and 4 or to represent values identifying OTS keys 3 and 4 (e.g. within a key structure such as a key tree structure). Based on such values as key information, it may be possible to obtain (e.g. retrieve or determine) the actual OTS keys 3 and 4.

For example, key information may be obtained in step 210 after HSM 110 received request information indicating OTS keys 3 and 4 (e.g. from an application requesting the transfer of OTS keys 3 and 4, such as e.g. an application as further described with reference to FIG. 5 and FIG. 6). Upon such a request, HSM 110 may determine whether OTS keys 3 and 4 are available (e.g. in the secure electronic memory of HSM 110) and unused.

Step 220 is determining, at least partially based on a plurality of session parameters and a master key, an encryption key, wherein the plurality of session parameters comprises a session identifier, a sender identifier and a receiver identifier.

For example, HSM 110 may determine an encryption key K_enc based on master key 150 stored in HSM 110 and based on a plurality of session parameters (e.g. by using a key derivation function). Therein, the plurality of session parameters comprises the sender identifier ID_S identifying HSM 110 as source apparatus, the receiver identifier ID_D identifying HSM 120 as destination apparatus and a session identifier session_ID identifying a transfer session between HSM 110 and HSM 120 for transferring key slice 140.

Step 230 is encrypting, at least partially based on the determined encryption key, the key information.

For example, using the encryption key K_enc determined in step 220, HSM 110 may encrypt the key information obtained in step 210.

Step 240 is providing payload information, wherein the payload information comprises at least the encrypted key information and the sender identifier.

For example, payload information provided by HSM 110 in step 240 comprises the key information representing the OTS keys 3 and 4 included in key slice 140 as encrypted in step 230 and the sender identifier ID_S. In addition, the payload information may further comprise the receiver identifier ID_D and the session identifier session_ID. HSM 110 may provide the payload information to HSM 120 over secure transfer channel 130, for example by providing the payload information in step 240 to the application which has requested the transfer of OTS keys 3 and 4.

Before or after step 240, HSM 110 may determine an updated state of OTS keys 3 and 4 by updating state information 180 to indicate that OTS keys 3 and 4 are used.

As additional option to steps 220 and 230, HSM 110 may determine an authentication information at least partially based on an authentication key, the key information and the plurality of session parameters, wherein the provided payload information further comprises the determined authentication information. This may for example comprise determining the authentication key at least partially based on the plurality of session parameters and the master key.

For example, HSM 110 may determine a message authentication code (MAC) as authentication information based on the key information obtained in step 210, the session parameters ID_S, ID_D and session_ID, and an authentication key K_mac. In addition to the encrypted key information, the payload information provided in step 240 then further comprises the MAC authenticating the key information. For encrypting and authenticating the key information, methods for achieving authenticated encryption such as Authenticated Encryption with Associated Data (e.g. AES-GCM) may be used by HSM 110. Further, authentication key K_mac used for authentication key information may be determined by HSM 110 based on session parameters ID_S, ID_D, session_ID and on master key 150.

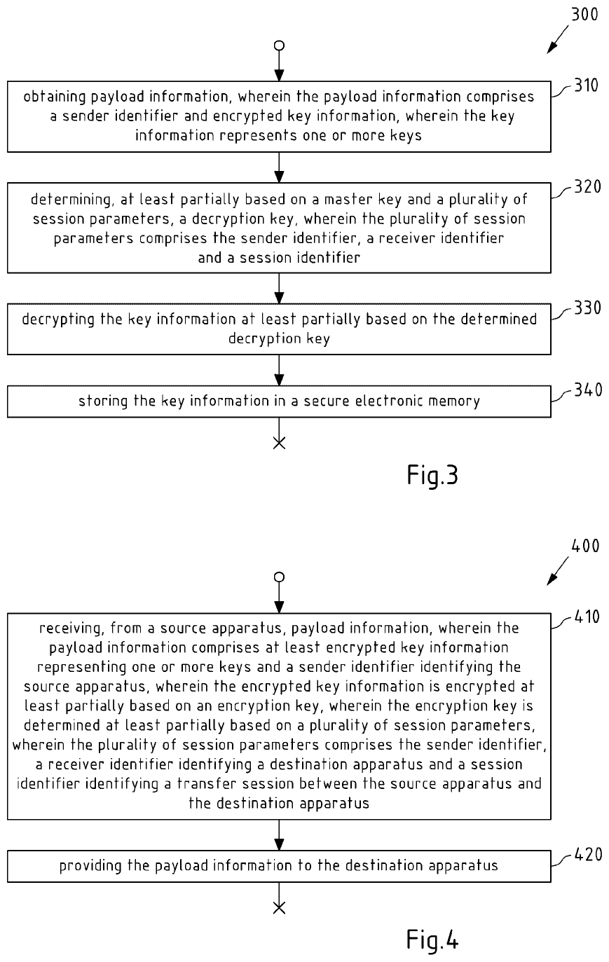

FIG. 3 shows a flow chart 300 illustrating an exemplary embodiment of a method according to the second aspect of the present disclosure. It may for example be assumed that the steps of flow chart 300 are performed and/or controlled by an apparatus according to the second aspect of the present disclosure (e.g. apparatus 700 described with reference to FIG. 7 as destination apparatus).

Without limiting the scope of the present disclosure, the steps of flow chart 300 are described in the following in view of system 100 according to FIG. 1.

Step 310 is obtaining payload information, wherein the payload information comprises a sender identifier and encrypted key information, wherein the key information represents one or more keys.

For example, HSM 120 obtains the payload information in step 310 after the payload information is provided by HSM 110 as described with reference to step 240 in FIG. 2. HSM 120 may obtain the payload information over secure transfer channel 130, for example from an application as further described with reference to FIG. 5 and FIG. 6.

The payload information obtained in step 310 may comprise the sender identifier ID_S identifying HSM 110 as source apparatus and the key information representing OTS keys 3 and 4 included in key slice 140 as encrypted by HSM 110 (see step 230 described with reference to FIG. 2). The payload information may further comprise the receiver identifier ID_D identifying HSM 120 as destination apparatus and the session identifier session_ID identifying the transfer session between HSM 110 and HSM 120 for transferring key slice 140. If the payload information comprises the receiver identifier ID_D, HSM 120 may verify after step 310 whether the receiver identifier ID_D included in the payload information matches a receiver identifier ID_D identifying HSM 120 that is stored at HSM 120 to verify that the payload information obtained in step 310 is intended for HSM 120.

Step 320 is determining, at least partially based on a master key and a plurality of session parameters, a decryption key, wherein the plurality of session parameters comprises the sender identifier, a receiver identifier and a session identifier.

For example, HSM 120 may determine a decryption key K_dec based on master key 150 stored in HSM 120 and based on the plurality of session parameters ID_S, ID_D and session_ID (e.g. by using a key derivation function), which has been used by HSM 110 to determine the encryption key K_enc as described with reference to step 220 in FIG. 2.

Considering the plurality of session parameters comprising the session parameters ID_S, ID_D and session_ID, all these session parameters may be included in the payload information obtained in step 310. In examples where the payload information does not include ID_D or session_ID, HSM 120 may determine these session parameters itself. Regarding ID_D, HSM 120 may assume its own ID_D stored at HSM 120 as ID_D, which means that HSM 120 assumes that the payload information obtained in step 310 was intended for HSM 120 even if the payload information lacks a corresponding session parameter ID_D explicitly identifying HSM 120 as destination apparatus. Regarding session_ID, HSM 120 may derive the session_ID from a previous session_ID stored at HSM 120, which identifies a previous transfer session between HSM 110 and HSM 120, by incrementally increasing the previous session_ID.

Step 330 is decrypting the key information at least partially based on the determined decryption key.

For example, using the decryption key K_dec determined in step 320, HSM 120 may decrypt the key information obtained in step 310.

Step 340 is storing the key information in a secure electronic memory.

For example, HSM 120 may store the key information decrypted in step 330 in a secure electronic memory of HSM 120, wherein the key information represents OTS keys 3 and 4 included in key slice 140. In this example, key information representing OTS keys 3 and 4 may be understood to represent the actual OTS keys 3 and 4 or represent values identifying OTS keys 3 and 4 (e.g. within a key structure such as a key tree structure). Based on such values as key information, HSM 120 may obtain (e.g. retrieve or determine) the actual OTS keys 3 and 4.

After step 340, HSM 120 may determine a state of OTS keys 3 and 4 indicating these keys as unused, which may ensure their freshness for any following use at HSM 120.

As additional option to steps 320 and 330, HSM 120 may verify the key information and the plurality of session parameter at least partially based on a verification key, authentication information included in the payload information obtained in step 310 and a verification key. This may for example comprise determining the verification key at least partially based on the plurality of session parameters and the master key. This additional option may for example be performed by HSM 120 in a case where the corresponding additional option to steps 220 and 230 of authenticating the key information are performed by HSM 110 as described with reference to FIG. 2.

For example, HSM 120 may determine a message authentication code (MAC) based on the key information, the session parameters ID_S, ID_D and session_ID included in the payload information obtained in step 310 and a verification key K_ver. For verifying the key information and the session parameters, the MAC determined by HSM 120 may be compared with the MAC that is included in the payload information and that is determined by HSM 110 as described with reference to FIG. 2. If the MAC determined by HSM 120 matches the MAC that is included in the payload information, the key information and the session parameters ID_S, ID_D and session_ID included in the payload information obtained in step 310 are verified. Further, the verification key K_ver used for verifying the key information and session parameters may be determined by HSM 120 based on the plurality of session parameters ID_S, ID_D and session_ID and master key 150 stored at HSM 120.

Advantageously, as described by the non-limiting example of the steps 210 to 240 performed by HSM 110 with reference to FIG. 2 and the corresponding steps 310 to 340 performed by HSM 120 with reference to FIG. 3, the present disclosure provides a secure transfer of one or more keys between the secure environment of a source apparatus and the secure environment of a destination apparatus.

With regard to security, using a symmetric encryption based on the symmetric master key shared between the HSMs allows for an increased resilience against quantum-based attacks. In contrast to symmetric encryption, asymmetric encryption used for example by a public key algorithm may exhibit weakness towards quantum-based attacks, which is avoided by using the symmetric master key. Further, the approach of the present disclosure protects against replay attacks and does not only guarantee local freshness of the keys, but also freshness for the transfer of the keys and thus freshness for an entire system in which the keys may be distributed. In combination with the secure handling of state information inside the HSMs, a secure handling of the state information for an entire set of trustworthy HSMs may be achieved. The access of each HSM may be restricted by design to a disjunct subset of OTS keys, so that it is guaranteed that each OTS key is used at most once.

With regard to flexibility, the described transfer of key slices may be executed at the time of key generation, but also at a later point in time. It may allow for transferring a specified portion of a key to another trustworthy HSM. For example, it may be possible to setup a local signing instance at a new production line. It may also be possible to transfer back key slices that were transferred previously, and not subsequently consumed while the security guarantees still hold and the corresponding states will be adapted automatically. Therefore, there is no need for an exclusive ,,Root HSM“, but all HSMs may be regarded as equal from a security perspective. Considering two HSMs as source apparatus and destination apparatus, these roles may be easily changed within a plurality of HSMs and correspondingly expressed by the session parameters (e.g. ID_S and ID_D). Avoiding hierarchy among HSMs also avoids a single point of failure and allows for local key and state management. The present approach further does not require any communication between HSM prior to the key transfer such as for example a process or protocol for initiating communication (e.g. a handshake). An application for transfer of the protocol messages may be implemented in manner different ways, for example by means of a network server but also via classical media like USB-Stick, CD/DVD or similar.

Advantageously, a vendor-lock-in may be addressed by using a well-defined standard format for the key slice transfer, which may be public and thus adapted by various vendors, allowing the customer to change their system and/or vendor at any time. This may allow for transferring keys in a mixed HSM environment with a plurality of HSMs from various vendors. For example, only the knowledge of the corresponding protection key (e.g. the master key) is required for an independent vendor to transfer key slices according to the present approach.

FIG. 4 shows a flow chart 400 illustrating an exemplary embodiment of a method according to the third aspect of the present disclosure.

Without limiting the scope of the present disclosure, the actions of flow chart 400 are described in following in view of system 100 according to FIG. 1 and with reference to the steps described in FIG. 2 and FIG. 3. It may for example be assumed that the steps of flow chart 400 are performed and/or controlled by an application. Such an application may be understood as an apparatus according to the third aspect of the present disclosure (e.g. apparatus 800), which may be a network server as part of a network that includes HSM 110 and HSM 120 and that may be used for key transfer. In another example, the application may be understood as a portable data storage device (e.g. a USB flash drive), on which the payload information may be temporarily stored and transferred from HSM 110 to HSM 120.

Step 410 is receiving, from a source apparatus, payload information, wherein the payload information comprises at least encrypted key information representing one or more keys and a sender identifier identifying the source apparatus, wherein the encrypted key information is encrypted at least partially based on an encryption key, wherein the encryption key is determined at least partially based on a plurality of session parameters, wherein the plurality of session parameters comprises the sender identifier, a receiver identifier identifying a destination apparatus and a session identifier identifying a transfer session between the source apparatus and the destination apparatus.

For example, the application receives from HSM 110 as source apparatus the payload information as provided by HSM 110 in step 240. The payload information comprises encrypted key information representing keys 3 and 4 included in key slice 140, the sender identifier ID_S identifying HSM 110 and optionally further session parameters ID_D identifying HSM 120 and session_ID identifying the transfer session between HSM 110 and HSM 120.

Step 420 is providing the payload information to the destination apparatus.

For example, the application provides the payload information received in step 410 to HSM 120 as destination apparatus, such that HSM 120 may obtain the payload information as described in step 310.

FIG. 5 shows a signalling chart 500 illustrating an exemplary embodiment according to the various aspects of the present disclosure. As a non-limiting example, signalling chart 500 includes steps S501 to S509, which may be performed by HSM 510 as source apparatus identified by sender identifier ID_S (see “Src HSM” in FIG. 5), HSM 520 as destination apparatus identified by receiver identifier ID_D (see “Dest HSM” in FIG. 5) and application 530. Master key MK may be stored at both HSM 510 and 520.

In step 501, application 530 sends a request to HSM 510, wherein HSM 510 is requested to send a particular key slice ks to HSM 520 identified by ID_D as included in the request. The request for example indicates one or more particular OTS keys that are to be sent in the key slice to HSM 520 identified by ID_D, or in another example indicates that a particular amount of OTS keys that is to be sent without specifying any particular OTS keys.

In step 502, HSM 510 verifies the request received in step 501, which may comprise determining whether the OTS keys indicated in the request are available at HSM 510 (e.g. in the secure electronic memory of HSM 510). If available, HSM 510 may further determine based on state information whether the corresponding OTS keys are unused. If the corresponding OTS keys are not available at HSM 510 or are available but already used, the method may be stopped at step 502. Otherwise, HSM 510 may obtain the OTS keys according to the request from the secure electronic memory of HSM 510. It may be assumed in the following that the actual OTS keys are transferred to HSM 520, but it is also possible to transfer identifiers of the OTS keys based on which the actual OTS keys may be determined at HSM 520.

In step 503, HSM 510 determines an encryption key K_enc and an authentication key K_mac as unique session keys for the present transfer session between HSM 510 and HSM 520. In this regard, step 503 and step 504 below refer to a non-limiting example using encryption as well as authentication for key transfer. In particular, the session keys K_enc and K_mac are derived based on master key MK and session parameters ID_S, ID_D (e.g. included in the request in step 501) and session_ID identifying the present transfer session between HSM 510 and HSM 520 (e.g. by using a key derivation function). HSM 510 may derive the session_ID from an internal, persistent session state by increasing the previous session state by 1, or by setting session_ID equal to 1 if no previous session state for transfer sessions between HSM 510 and HSM 520 is available at HSM 510. In this case, HSM 510 has the role “sender” and HSM 520 has the role “receiver”, which means that an identifier of HSM 510 is used as ID_S and an identifier of HSM 520 is used as ID_D. In another case in which HSM 510 receives keys from HSM 520, the roles and corresponding identifiers ID_D and ID_S may be reversed.

In step 504, the session keys K_enc and K_mac derived in step 503 are used to encrypt and authenticate the key slice including OTS keys indicated in the request received in step 501 for generating the payload information (see “Payload =AuthEnc[K_enc, K_mac] (keyslice)” in FIG. 5). For example, an Authenticated Encryption Mode such as AES-GCM may be used for encrypting and authenticating the key slice. In the non-limiting example of step 504, not only the OTS keys included in the key slice but also the session parameters ID_S, ID_D and session_ID are authenticated. By authenticating the key slice and the session parameters, a MAC as authentication information is determined based on the encrypted key slice, the session parameters and K_mac determined in step 503, wherein the MAC is then included in the payload information. The payload information generated in step 504 then comprises the encrypted and authenticated key slice, the authenticated session parameters ID_S, ID_D and session_ID and the MAC.

In steps 505 and 506, the payload information generated in step 504 is transferred from HSM 510 to HSM 520. In the non-limiting example of FIG. 5 including application 530 for transferring the payload information, the payload information may be provided by HSM 510 to application 530 in step 505 and then sent from application 530 to HSM 520 in step 506.

Application 530 may be understood as an apparatus according to the third aspect of the present disclosure (e.g. apparatus 800), which may be a network server as part of a network that includes HSM 510 and HSM 520 and that may be used for key transfer. In such a case, the network server may receive the payload information from HSM 510 in step 505 (e.g. by means of communication interfaces of HSM 510 and the network server) and may then forward the payload information in step 506 to HSM 520 (e.g. by means of communication interfaces of HSM 520 and the network server).

In another example, application 530 may be understood as a portable data storage device (e.g. a USB flash drive), on which the payload information may be temporarily stored and transferred from HSM 510 to HSM 520. In such a case, the portable data storage device may receive the payload information from HSM 510 in step 505 (e.g. by receiving and storing the payload information on the portable data storage device) and may then forward the payload information in step 506 to HSM 520 (e.g. by retrieving and outputting the payload information from the portable data storage device).

In step 507, HSM 520 determines a decryption key K_dec and a verification key K_ver as unique session keys for the present transfer session between HSM 510 and HSM 520. HSM 520 determines the decryption key K_dec and the verification key K_ver based on the master key MK stored in HSM 520 and based on the plurality of session parameters ID_S, ID_D and session_ID (e.g. by using respective key derivation functions), which have been used by HSM 510 to determine the encryption key K_enc and the authentication key K_mac as described in step 503. In the non-limiting example of FIG. 5, the session parameters ID_S, ID_D and session_ID are included in the payload information and thus are used to determine K_dec and K_ver. In examples where the payload information does not include ID_D or session_ID, HSM 520 may assume its own ID_D stored at HSM 520 as ID_D and may further derive the session_ID from a previous session_ID stored at HSM 520.

Before determining the session keys K_dec and K_ver, HSM 520 may verify the receiver identifier ID_D included in the payload information by checking whether the receiver identifier ID_D included in the payload information transferred in steps 505 and 506 matches a receiver identifier ID_D identifying HSM 520 that is stored at HSM 520 to verify that the transferred payload information is intended for HSM 520.

In step 508, HSM 520 extracts the payload information received in step 506 using the session keys determined in step 507. In the non-limiting example of FIG. 5, extracting the payload information comprises verifying the encrypted key information representing the OTS keys included in the key slice as well as the session parameters ID_S, ID_D and session_ID included in the payload information. For verification, HSM 520 determines a MAC based on the encrypted key information, the session parameters ID_S, ID_D and session_ID included in the payload information and the verification key K_ver determined in step 507. For verifying the key information and the session parameters, the MAC determined by HSM 520 may be compared with the MAC that is included in the payload information and that is determined by HSM 510 in step 504. If the MAC determined by HSM 520 matches the MAC that is included in the payload information, the key information and the session parameters ID_S, ID_D and session_ID included in the payload information received in step 506 are verified.

Further in step 508, HSM 520 decrypts the encrypted key information using the decryption key K_dec determined in step 507. The authenticity of the payload information together with the session parameters guarantees the freshness of the key slice and may allow for detecting a replay attack. The encrypted key slice including the OTS keys as indicated in the request of step 501 is then stored for further use in the secure electronic memory of HSM 520. For this purpose, HSM 520 may determine state information of the transferred OTS keys indicating that these OTS keys are unused.

In step 509, HSM 520 may confirm to application 530 that the transferred OTS keys have been received at HSM 520, for example by providing corresponding status information indicating the OTS keys to application 530.

FIG. 6 shows an exemplary embodiment of a system 600 according to the fourth aspect of the present disclosure.

Without limiting the scope of the present disclosure, system 600 may comprise at least four apparatuses. Therein, HSM 610 (see “Src HSM” in FIG. 6) may be understood as source apparatus and HSM 620 (see “Dest HSM” in FIG. 6) may be understood as destination apparatus. Further, application 630 may be understood as a network server that is part of a network including HSM 610 and HSM 620 and that may be used for key transfer between HSM 610 and HSM 620. In addition, system 600 may include at least one further HSM 640 (see “Dest HSM” in FIG. 6) that may be understood as at least one further destination apparatus. As shown in FIG. 6, HSM 640 may for example have stored the master key MK and may be identified by a receiver identifier ID_D.

Considering system 600, it may be assumed that a key transfer between HSM 610 and HSM 620 involving application 630 may be performed in a corresponding manner as described in the example of FIG. 5 for HSM 510, HSM 520 and application 530. Accordingly, HSM 610 is identified by sender identifier ID_S, HSM 620 is identified by receiver identifier ID_D, and session identifier session_ID identifies a transfer session between HSM 610 and HSM 620 for transferring payload information that includes an encrypted key slice with one or more OTS keys.

In the beginning of a key transfer session, HSM 610 may be requested by application 630 to send a particular key slice to HSM 620 (see step 501 as described with reference to FIG. 5). For example, after verifying the request at HSM 610, determining session keys and generating the payload information (see steps 502 to 504 as described with reference to FIG. 5), HSM 610 may provide to application 630 an indication of the one or more OTS keys included in the key slice that is transferred in the payload information to application 630. Such an indication of the one or more OTS keys may be understood as the actual OTS keys or as values identifying the OTS keys.

Application 630 receives the indication of the one or more OTS keys from HSM 610 and subsequently transmits a request to HSM 640 to indicate whether the one or more OTS keys are unused. HSM 640 may then check if any information (e.g. state information) on the one or more OTS keys is available at HSM 640 that may indicate that the one or more OTS keys have been used before or have been transferred to HSM 640 before (e.g. in a previous transfer session between HSM 610 and HSM 640). In response to the request by application 630, HSM 640 may then transmit confirmation information indicating whether the one or more OTS keys are unused. This may be understood to mean that the confirmation information may at least indicate whether the one or more OTS keys have not been used at HSM 640 or have not been transferred to HSM 640 before, while it may still be that they have been used at another HSM or transferred to another HSM that may be part of system 600.

After receiving the confirmation information from HSM 640, application 630 may provide the confirmation information to HSM 620. HSM 620 may then obtain the confirmation information and check whether the OTS keys that HSM 620 received from HSM 610 (see step 506 as described with reference to FIG. 5) are unused. For example, HSM 620 may only use the OTS keys transferred from HSM 610 (e.g. only decrypt and/or store the OTS keys in the secure electronic memory of HSM 620) if the confirmation information indicate that the OTS keys have not been used before. Otherwise, HSM 620 may discard the transferred OTS keys.

While the non-limiting example of a system in FIG. 6 illustrates only one further destination apparatus by HSM 640, it may be understood that a system may comprise any number of further destination apparatuses in addition to HSM 620. In general, assuming that system 600 includes a plurality of HSM as destination apparatuses, application 630 may request at each HSM to indicate whether the one or more OTS keys are unused and may then forward confirmation information from each HSM to HSM 620. HSM 620 may then only use the OTS keys transferred from HSM 610 (e.g. store the OTS keys in the secure electronic memory of HSM 620) if each confirmation information of the plurality of confirmation information indicates that the OTS keys have not been used before. Otherwise, HSM 620 may discard the transferred OTS keys.

Advantageously, HSM 620 within system 600 may then use the confirmation information from further HSM 640 to ensure that transferred OTS keys are unused. This way, HSM 640 may detect replay attacks by checking whether received OTS keys have been transferred in a previous transfer session to another HSM of system 600.

FIG. 7 shows a block diagram of an exemplary embodiment of an apparatus according to the first (e.g. a source apparatus) or second aspect (e.g. a destination apparatus) of the present disclosure. As such, apparatus 700 may for example be configured to perform the steps of flow chart 200 illustrated in FIG. 2 or the step of flow chart 300 illustrated in FIG. 3.

Apparatus 700 may comprise a processor 701 which may represent a single processor or two or more processors (which e.g. are at least partially coupled, e.g. via a bus). Processor 701 may execute a program code stored in program memory 702 (e.g. program code causing apparatus 700 to perform embodiments according to the present disclosure or parts thereof) and may interface with a main memory 703. Program memory 702 may further comprise an operating system (e.g. a Linux-based operating system) for processor 701. Some or all of memories 702 and 703 may also be included into processor 701.

Moreover, processor 701 may control one or more communication interface(s) 704 which may be configured to communicate with further apparatuses. The one or more communication interface(s) 704 may provide one or more wireline and/or wireless connections. To give some non-limiting examples, a wireline connection may be serial connection (e.g. according to the RS-232 standard), an Ethernet connection (according to any release of the IEEE-802.3 standard) and/or a Universal Serial Bus (USB) connection (e.g. according to any release of the USB standard). Non-limiting examples for a wireless connection may be a Wireless Local Area Network (WLAN) connection (e.g. according to the IEEE-802.11 standard family) or a Bluetooth connection (e.g. according to any release of the IEEE-802.15.1 standard).

In a non-limiting example, apparatus 700 may be understood as an HSM or a component of an HSM as described with reference to FIG. 1. Processor 701 may then be a secure cryptographic processor and memory 702 and/or memory 703 may be a secure electronic memory secured by physical security measures. It may be understood that apparatus 700 may comprise further components, such as for example further components of an HSM.

FIG. 8 shows a block diagram of an exemplary embodiment of an apparatus according to the third aspect of the present disclosure. As such, apparatus 800 may for example be configured to perform the steps of flow chart 400 illustrated in FIG. 4.

Apparatus 800 may comprise a processor 801 which may represent a single processor or two or more processors (which e.g. are at least partially coupled, e.g. via a bus). Processor 801 may execute a program code stored in program memory 802 (e.g. program code causing apparatus 800 to perform embodiments according to the present disclosure or parts thereof) and may interface with a main memory 803. Program memory 802 may further comprise an operating system (e.g. a Linux-based operating system) for processor 801. Some or all of memories 802 and 803 may also be included into processor 801.

Moreover, processor 801 may control one or more communication interface(s) 804 which may be configured to communicate with further apparatuses (e.g. apparatus 700). The one or more communication interface(s) 804 may provide one or more wireline and/or wireless connections. To give some non-limiting examples, a wireline connection may be serial connection (e.g. according to the RS-232 standard), an Ethernet connection (according to any release of the IEEE-802.3 standard) and/or a Universal Serial Bus (USB) connection (e.g. according to any release of the USB standard). Non-limiting examples for a wireless connection may be a Wireless Local Area Network (WLAN) connection (e.g. according to the IEEE-802.11 standard family) or a Bluetooth connection (e.g. according to any release of the IEEE-802.15.1 standard).

In a non-limiting example, apparatus 800 may be understood as a network server that may be configured to manage a network including at least two apparatuses as described with reference to FIG. 7 (e.g. at least two HSM).

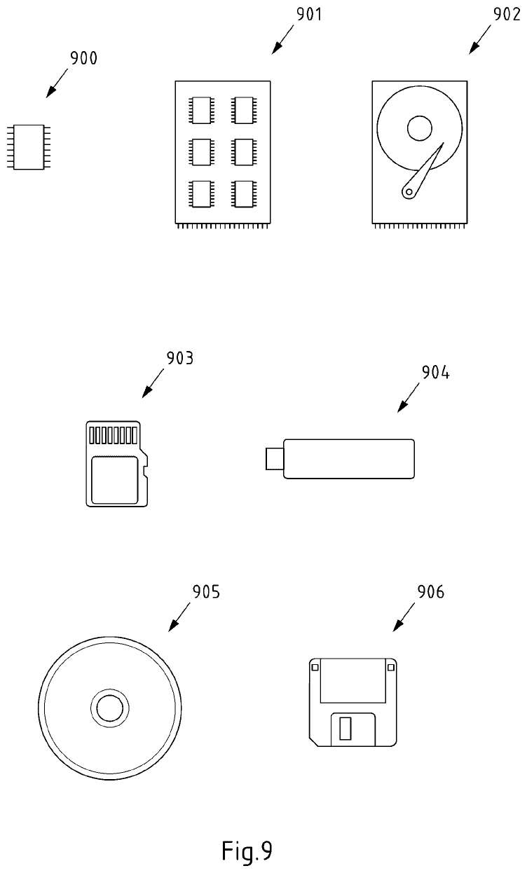

FIG. 9 is a schematic illustration of examples of tangible and non-transitory computer-readable storage media according to the present disclosure that may for example be used to implement memory 702 of FIG. 7 and/or memory 802 of FIG. 8. To this end, FIG. 9 displays a flash memory 900, which may for example be soldered or bonded to a printed circuit board, a solid-state drive 901 comprising a plurality of memory chips (e.g. Flash memory chips), a magnetic hard drive 902, a Secure Digital (SD) card 903, a Universal Serial Bus (USB) memory stick 904, an optical storage medium 905 (such as for example a CD-ROM or DVD) and a magnetic storage medium 906.

Any presented connection in the disclosed embodiments is to be understood in a way that the involved components are operationally coupled. Thus, the connections can be direct or indirect with any number or combination of intervening elements, and there may be merely a functional relationship between the components.

Any of the processors mentioned in the present disclosure may be a processor of any suitable type. Any processor may comprise but is not limited to one or more microprocessors, one or more processors with accompanying digital signal processors, one or more processors without accompanying digital signal processors, one or more special-purpose computer chips, one or more field-programmable gate arrays (FPGAS), one or more controllers, one or more application-specific integrated circuits (ASICS), or one or more computers. The relevant structure/hardware has been programmed in such a way to carry out the described function.

Moreover, any of the actions or steps described or illustrated in the present disclosure may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method comprising:
receiving request information indicating one or more keys;
determining whether the one or more keys indicated by the request information are available and unused;
obtaining key information from a secure electronic memory, wherein the key information represents the one or more keys;
determining, at least partially based on a plurality of session parameters and a master key, an encryption key, wherein the plurality of session parameters comprises a session identifier, a sender identifier and a receiver identifier;
encrypting, at least partially based on the determined encryption key, the key information; and
providing, by a source apparatus, payload information, wherein the payload information comprises at least the encrypted key information and the sender identifier,
wherein the one or more keys are one-time signature keys, wherein the payload information is transferred from the source apparatus to a destination apparatus, and wherein the following holds:
the sender identifier identifies the source apparatus;
the receiver identifier identifies the destination apparatus; and
the session identifier identifies a transfer session between the source apparatus and the destination apparatus for transferring the payload information.

2. The method according to claim 1, wherein the provided payload information further comprises the session identifier and the receiver identifier.

3. The method according to claim 1, wherein the method further comprises:
determining an authentication information at least partially based on an authentication key, the key information and the plurality of session parameters, wherein the provided payload information further comprises the determined authentication information.

4. The method according to claim 3, wherein the method further comprises:
determining the authentication key at least partially based on the plurality of session parameters and the master key.

5. The method according to claim 1, wherein the method further comprises:
determining an updated state of the one or more keys.

6. The method according to claim 1, wherein the method further comprises:
providing an indication of the one or more keys represented by the key information.

7. A method comprising:
obtaining, at a destination apparatus, payload information, wherein the payload information comprises a sender identifier and encrypted key information, wherein the key information represents one or more keys;
determining, at least partially based on a master key and a plurality of session parameters, a decryption key, wherein the plurality of session parameters comprises the sender identifier, a receiver identifier and a session identifier;
decrypting the key information at least partially based on the determined decryption key; and
storing the key information in a secure electronic memory, wherein the method further comprises:
obtaining confirmation information indicating whether the one or more keys represented by the key information are unused, wherein the key information is stored in the secure electronic memory when the confirmation information indicates that the one or more keys are unused,
wherein the one or more keys are one-time signature keys, and
wherein the payload information is transferred from a source apparatus to the destination apparatus, and wherein the following holds:
the sender identifier identifies the source apparatus;
the receiver identifier identifies the destination apparatus; and
the session identifier identifies a transfer session between the source apparatus and the destination apparatus for transferring the payload information.

8. The method according to claim 7, wherein the obtained payload information further comprises the session identifier and the receiver identifier.

9. The method according to claim 8, wherein the method further comprises:
verifying, before determining the decryption key, the receiver identifier included in the payload information.

10. The method according to claim 7, wherein the obtained payload information further comprises an authentication information and wherein the method comprises:
verifying the key information and the plurality of session parameters, at least partially based on the authentication information and a verification key.

11. The method according to claim 10, the method further comprising:
determining the verification key at least partially based on the plurality of session parameters and the master key.

12. The method according to claim 7, wherein the method further comprises:
providing status information indicating the one or more keys.

13. The method according to claim 7, wherein the method further comprises:
determining a state of the one or more keys.

14. The method according to claim 1, wherein the one or more keys represent a key slice.

15. An apparatus configured to perform and/or comprising means for performing the method according to claim 1.

16. An apparatus configured to perform and/or comprising means for performing the method according to claim 7.

17. A system comprising the apparatus according to claim 15 and an apparatus configured to perform and/or comprising means for performing a method comprising:
obtaining, at a destination apparatus, payload information, wherein the payload information comprises a sender identifier and encrypted key information, wherein the key information represents one or more keys;
determining, at least partially based on a master key and a plurality of session parameters, a decryption key, wherein the plurality of session parameters comprises the sender identifier, a receiver identifier and a session identifier;
decrypting the key information at least partially based on the determined decryption key; and
storing the key information in a secure electronic memory, wherein the method further comprises:
obtaining confirmation information indicating whether the one or more keys represented by the key information are unused, wherein the key information is stored in the secure electronic memory when the confirmation information indicates that the one or more keys are unused,
wherein the one or more keys are one-time signature keys, and
wherein the payload information is transferred from a source apparatus to the destination apparatus, and wherein the following holds:
the sender identifier identifies the source apparatus;
the receiver identifier identifies the destination apparatus and
the session identifier identifies a transfer session between the source apparatus and the destination apparatus for transferring the payload information.
